(19) United States
(12) Patent Application Publication
(10) Pub. No.: US 2015/0081094 A1
(43) Pub. Date: Mar. 19, 2015

(54) GENERAL-PURPOSE PERIPHERAL INTERFACE, A METHOD OF INTERFACING, AND AN APPARATUS HAVING THE SAME FOR CONTROLLING A ROBOT

(71) Applicants: Byoung-Soo Kim, Seoul (KR); In Yong Ha, Seoul (KR)

(72) Inventors: Byoung-Soo Kim, Seoul (KR); In Yong Ha, Seoul (KR)

(73) Assignee: ROBOTIS CO., LTD., Seoul (KR)

(21) Appl. No.: 14/360,300

(22) PCT Filed: May 21, 2012
(86) PCT No.: PCT/KR2012/004003

§ 371 Date: Jul. 6, 2014

(30) Foreign Application Priority Data
May 21, 2012 (KR) 10-2012-0053590

(51) Int. Cl. B25J 9/16

(52) U.S. Cl. CPC B25J 9/16
USPC 700/245; 327/524

(57) ABSTRACT

A general-purpose peripheral interface according to an exemplary embodiment of the present invention includes a pair of complementary connectors including at least one input terminal, at least one output terminal, and at least one power supply terminal and ground terminal, wherein when a connector of a peripheral device is combined to a connector of a control device, an identification voltage in a voltage range varying according to a type of the peripheral device is shown in the input terminal. Here, the voltage ranges may be set not to overlap each other when the types of the peripheral devices are different. The type of the peripheral device may be one of an input type, an input-output mixed type, and an output type.

### CROSS REFERENCE TO RELATED APPLICATIONS AND CLAIM OF PRIORITY

This patent application is a National Phase application under 35 U.S.C. §371 of International Application No. PCT/KR2012/004003, filed May 21, 2012, which claims priority to Korean Patent Application No. 10-2012-0053590 filed May 21, 2012, entire contents of which are incorporated herein by reference.

### BACKGROUND

1. Field of the Invention

The present invention relates to an interface circuit, and more specifically, a general-purpose peripheral interface.

2. Discussion of Related Art

Generally, a robot includes peripheral devices, such as a sensor, an actuator, a display device, or an input device, and a control device systematically controlling the peripheral devices to implement a desired operation. Such configuration is substantially the same in highly sophisticated military or industrial robots and a simplified educational robot.

In order for a robot control device to control peripheral devices, such as a number of sensors, motors, cylinders, transmissions, displays, lamps, and input devices, a number of interface circuits are required.

Since performance and efficiency are prioritized rather than manufacturing costs in military or industrial robots, it may not be a big problem for the military or industrial robots to have individually optimized interface structures according to characteristics of each peripheral device.

However, educational robots may need to be inexpensively supplied, to have high durability, and, at the same time, to be easily understood by students. Nevertheless, since existing educational robots adopt an individual interface circuit structure for each peripheral device, manufacturing costs increase. Thus, it is difficult to inexpensively supply the existing educational robots to students. In addition, it is difficult for students to easily understand and assemble the existing educational robots.

In addition, depending on structures of robots, the types and numbers of interface circuits may not be enough to correspond to those of peripheral devices. For example, when practicing fabrication of an educational robot which needs to control six motors, it is impossible from the start to practice the fabrication of the educational robot if the educational robot has only four interfaces for motors.

### SUMMARY OF THE INVENTION

The present invention is directed to a general purpose peripheral interface which has a unified port structure regardless of characteristics of peripheral devices, identifies the type of a connected peripheral device, and uses a corresponding port as an interface for the identified peripheral device, a robot control device including the same, and a method of interfacing.

According to an aspect of the present invention, there is provided a general-purpose peripheral interface including a pair of complementary connectors having at least one input terminal, at least one output terminal, and at least one power supply terminal and ground terminal, wherein when a connector of a peripheral device is combined to a connector of a control device, an identification voltage in a voltage range varying according to the type of the peripheral device is shown in the input terminal.

In some exemplary embodiments, the voltage ranges may be set not to overlap each other when the types of the peripheral devices are different.

In other exemplary embodiments, the type of the peripheral device may be one of an input type, an input-output mixed type, and an output type.

In still other exemplary embodiment, when the type of the peripheral device is the input type, the at least one output terminal may be floating, and the input terminal may show the identification voltage in a voltage range relatively closer to a ground voltage. When the type of the peripheral device is the output type, the at least one output terminal may output a control signal for the peripheral device, and the input terminal may show the identification voltage in a voltage range relatively closer to a power supply voltage.

In still other embodiments, when the type of the peripheral device is the input type, the at least one output terminal may be floating, and the input terminal may show the identification voltage in a first voltage range relatively closer to a ground voltage. When the type of the peripheral device is the output type, the at least one output terminal may output a control signal for the peripheral device, and the input terminal may show the identification voltage in a third voltage range relatively closer to a power supply voltage. When the type of the peripheral device is the input-output mixed type, the at least one output terminal may output a control signal for the peripheral device, and the input terminal may show the identification voltage in a second voltage range between the first voltage range and the third voltage range.

According to another aspect of the present invention, there is provided a robot control device implementing a robot function using at least one peripheral device including a general-purpose peripheral interface using a pair of complementary connectors including at least one input terminal, at least one output terminal, and at least one power supply terminal and ground terminal, wherein when a connector of the peripheral device is combined to a connector of the robot control device, an identification voltage in a voltage range varying according to the type of the peripheral device is shown in the input terminal, and an identifier identifying the type of the peripheral device as one of an input type, an input-output mixed type, and an output type according to the voltage range of the identification voltage.

In some embodiments, when the type of the peripheral device is the input type, the at least one output terminal may be floating and the input terminal may show the identification voltage in a first voltage range relatively closer to a ground voltage. When the type of the peripheral device is the output type, the at least one output terminal may output a control signal for the peripheral device, and the input terminal may show the identification voltage in a third voltage range relatively closer to a power supply voltage. When the type of the peripheral device is the input-output mixed type, the at least one output terminal may output a control signal for the peripheral device, and the input terminal may show the identification voltage in a second voltage range between the first voltage range and the third voltage range.

According to still another aspect of the present invention, there is provided a method of general-purpose peripheral interfacing for a robot control device implementing a robot function using at least one peripheral device including supplying, by each of the robot control device and the peripheral device, a pair of complementary interface connectors which include at least one input terminal, at least one output terminal, and at least one power supply terminal and ground terminal and electrically combine with each other, measuring an identification voltage shown in the at least one input terminal when corresponding terminals of the pair of complementary interface connectors are electrically connected to each other, and identifying the type of the peripheral device according to a voltage range of the identification voltage.

In some embodiments, the identifying of the type of the peripheral device according to the voltage range of the identification voltage may include determining to which one among first to third voltage ranges which do not overlap each other between a power supply voltage and a ground voltage the identification voltage belongs, and determining the type of the peripheral device as one of an input type, an output type, and an input-output mixed type according to the determined voltage range to which the identification voltage belongs.

In other embodiments, when the type of the peripheral device is the input type, the at least one output terminal may be floating and the input terminal may show the identification voltage in the first voltage range relatively closer to the ground voltage. When the type of the peripheral device is the output type, the at least one output terminal may output a control signal for the peripheral device, and the input terminal may show the identification voltage in the third voltage range relatively closer to the power supply voltage. When the type of the peripheral device is the input-output mixed type, the at least one output terminal may output a control signal for the peripheral device, and the input terminal may show the identification voltage in the second voltage range between the first voltage range and the third voltage range.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a conceptual diagram showing a general-purpose peripheral interface and a robot control device including the same according to an exemplary embodiment of the present invention;

FIG. 2 is a diagram showing an example of a basis by which a control device identifies a peripheral device connected through a general-purpose peripheral interface according to an exemplary embodiment of the present invention;

FIG. 3 shows circuit diagrams of peripheral devices, which are exemplarily illustrated by types, connected through a general-purpose peripheral interface according to an exemplary embodiment of the present invention; and

FIG. 4 is a flowchart showing a method of interfacing a general-purpose peripheral device, by which a control device identifies a peripheral device connected through a general-purpose peripheral interface according to an exemplary embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

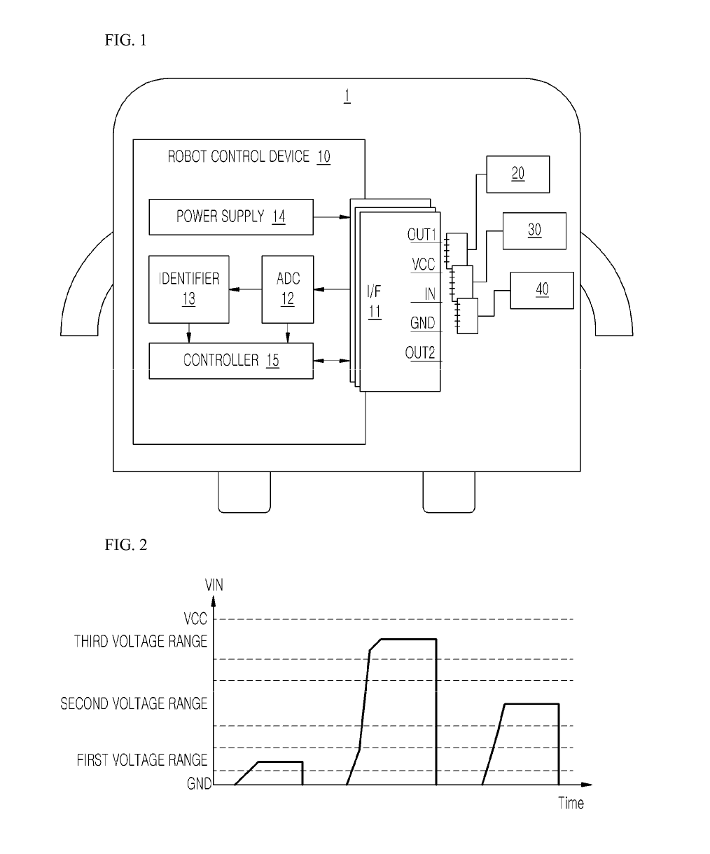

FIG. 1 is a conceptual diagram showing a general-purpose peripheral interface and a robot control device including the same according to an exemplary embodiment of the present invention.

Referring to FIG. 1, an educational robot 1 may include a robot control device 10, an input-type peripheral device 20, an output-type peripheral device 40, and a mixed-type peripheral device 30 such as an actuator, and the robot control device 10 may include a general-purpose peripheral interface (I/F) 11 capable of having a plurality of channels, an analog-to-digital converter (ADC) 12, an identifier 13, a power supply 14, and a controller 15.

The general-purpose peripheral interface 11 may include a plurality of interface channels. Each of the interface channels is configured using a pair of complementary connectors including at least one input terminal IN, at least one output terminal OUT1 and OUT2, and at least one power supply terminal VCC and ground terminal GND. Since the input terminal IN and the output terminal OUT1 and OUT2, and the power supply terminal VCC and the ground terminal GND are preferably spaced apart from each other, the terminals may be arranged in the order of a first output terminal OUT1, the power supply terminal VCC, the input terminal IN, a second output terminal OUT2, and the ground terminal GND.

The input terminal IN is basically a terminal receiving an input signal from the input-type peripheral device 20, such as a sensor, generating the input signal, and additionally a terminal receiving different levels of initial identification voltages according to the types of the peripheral devices 20, 30, and 40.

In addition, in the mixed-type peripheral device 30, such as a feedback cylinder, a servo motor, and a photo-coupler, in which both input and output can occur, an input of an input signal in the input terminal IN and an output of an output signal in the output terminal OUT1 and OUT2 may occur at the same time.

The output terminal OUT1 and OUT2 may be a terminal providing an output signal to the output-type peripheral device 40, such as an LED lamp, which is operated by receiving the output signal.

The ADC 12 is connected to the input terminal IN, converts an analog input signal received by the input terminal IN to a digital value, and transmits the converted digital value to the identifier 13.

The identifier 13 may identify the type of a connected peripheral device 20, 30, or 40 based on the converted digital value of the identification voltage applied to the input terminal IN during an initial connection time of the peripheral devices 20, 30, and 40. The identifier 13 may transmit information of the types of the peripheral devices 20, 30, and 40 as a result of the identification to the controller 15.

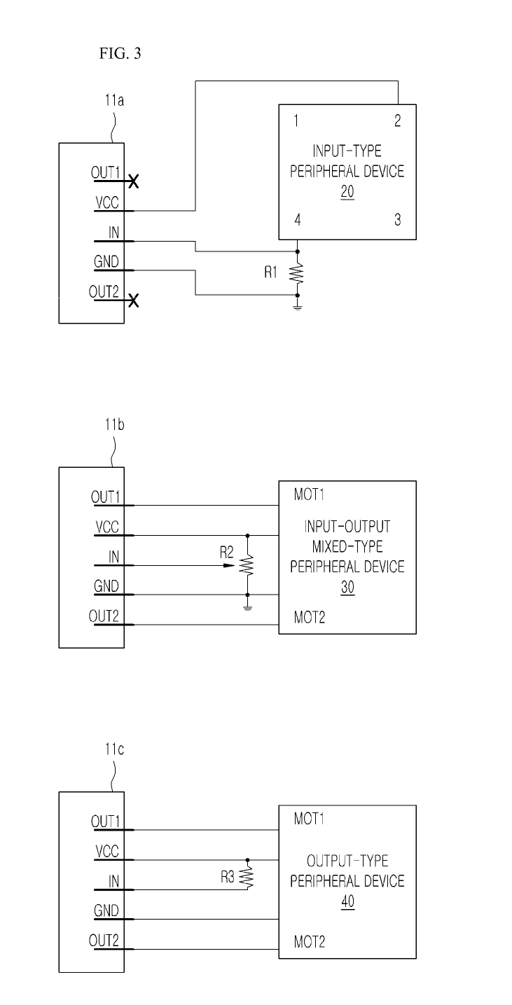

A specific procedure of the identifier 13 identifying the type of the peripheral device 20, 30, or 40 based on the identification voltage will be described with reference to FIGS. 2 and 3.

FIG. 2 is a diagram showing an example of a basis by which a control device identifies an peripheral device connected through a general-purpose peripheral interface according to an exemplary embodiment of the present invention, and FIG. 3 shows circuit diagrams of peripheral devices, which are exemplarily illustrated by types, connected through a general-purpose peripheral interface according to an exemplary embodiment of the present invention.

Referring to FIG. 2, the identifier 13 may identify the type of the peripheral device 20, 30, or 40 according to a converted digital value, that is, a level of an identification voltage received by an identifier 13.

First, since the input terminal IN is in a floating state until the peripheral device 20, 30, or 40 is connected, whether the peripheral device 20, 30, or 40 is connected or not may be known.

When a certain peripheral device 20, 30, or 40 is connected, the input terminal IN maintains a voltage state within any one among a first voltage range close to a ground voltage GND level, a second voltage range specified between the ground voltage GND level and a power supply voltage VCC level, and a third voltage range close to the power supply voltage VCC level, during at least the identification time.

Preferably, the first, second, and third voltage ranges may be set not to overlap each other.

During the identification time, the identification voltage is converted to a digital value by the ADC 12 and supplied to the identifier 13.

The identifier 13 may determine the type of the connected peripheral device 20, 30, or 40 as one of the input-type peripheral device 20, the mixed-type peripheral device 30, and the output-type peripheral device 40, according to which one among the three voltage ranges the level of the identification voltage measured in the input terminal IN belongs to.

Referring to FIG. 3, the input-type peripheral device 20, the mixed-type peripheral device 30, and the output-type peripheral device 40 are respectively connected to general-purpose peripheral interfaces 11a, 11b, and 11c. Since the connections shown in FIG. 3 are entirely exemplary and simplified for convenience of explanation, the connection is not limited thereto.

First, the input-type peripheral device 20 such as a touch sensor is connected to the general-purpose peripheral interface 11a.

Since the output terminals OUT1 and OUT2 of the general-purpose peripheral interface 11a are not used, the output terminals OUT1 and OUT2 are in a floating state, the power supply terminal VCC is connected to a terminal 2 of the input-type peripheral device 20 so as to supply power to the input-type peripheral device 20.

The input terminal IN of the general-purpose peripheral interface 11a is connected to a terminal 4 of the input-type peripheral device 20, and the terminal 4 of the input-type peripheral device 20 is connected to the ground terminal GND through a predetermined amount of feedback resistor R1.

In this way, when the input-type peripheral device 20 is connected, at least until the input-type peripheral device 20 starts an operation, the identification voltage in the input terminal IN of the general-purpose peripheral interface 11a lies within the voltage level of the terminal 4 of the input-type peripheral device 20, that is, the first voltage range close to the ground voltage GND level. Accordingly, the identifier 13 may identify the peripheral device inserted in the general-purpose peripheral interface 11a as the input-type peripheral device.

In this case, when the input-type peripheral device 20 starts an operation to generate an input signal, the generated input signal is input to the input terminal IN. Accordingly, the input terminal IN may not stay any more within the first voltage range close to the ground voltage GND level.

Next, the mixed-type peripheral device 30 such as a servo motor is connected to the general-purpose peripheral interface 11b.

Output terminals OUT1 and OUT2 of the general-purpose peripheral interface 11b may be respectively connected to control terminals MOT1 and MOT2 of the mixed-type peripheral device 30. The VCC terminal and the GND terminal are respectively connected to a power supply terminal and a ground terminal of the mixed-type peripheral device 30 so as to supply power to the mixed-type peripheral device 30.

An input terminal IN of the general-purpose peripheral interface 11b is connected an intermediate tap of a variable resistor R2, which is disposed between the power supply voltage VCC and the ground voltage GND, for measuring an electric potential. The identification voltage may lie within the second voltage range specified between the ground voltage GND and the power supply voltage VCC by presetting an appropriate value of the variable resistor R2.

In this way, when the mixed-type peripheral device 30 is connected, the identification voltage in the input terminal IN of the general-purpose peripheral interface 11b lies within the second voltage range specified between the ground voltage GND and the power supply voltage VCC by the variable resistor R2 of the mixed-type peripheral device 30. Accordingly, the identifier 13 may identify the peripheral device inserted in the general-purpose peripheral interface 11b as the mixed-type peripheral device. After the identifier 13 identifies the peripheral device as the mixed-type peripheral device, the controller 15 may output a control signal for controlling the output-type peripheral device 30 to the output terminals OUT1 and OUT2 of the general-purpose peripheral interface 11b.

Next, the output-type peripheral device 40 such as an LED lamp is connected to the general-purpose peripheral interface 11c.

Output terminals OUT1 and OUT2 of the general-purpose peripheral interface 11c are connected to control terminals MOT1 and MOT2 of the output-type peripheral device 40. The power supply terminal VCC and the ground terminal GND are connected to a power supply terminal and a ground terminal of the output-type peripheral device 40 so as to supply power to the output-type peripheral device 40. An input terminal IN of the general-purpose peripheral interface 11c may be connected to the power supply terminal of the output-type peripheral device 40 through a current limiting resistor R3.

In this way, when the output-type peripheral device 40 is connected, the identification voltage in the input terminal IN of the general-purpose peripheral interface 11c may lie within a voltage level close to the power supply voltage VCC, that is, within the third voltage range. Accordingly, the identifier 13 may identify the peripheral device inserted in the general-purpose peripheral interface 11c as the output-type peripheral device.

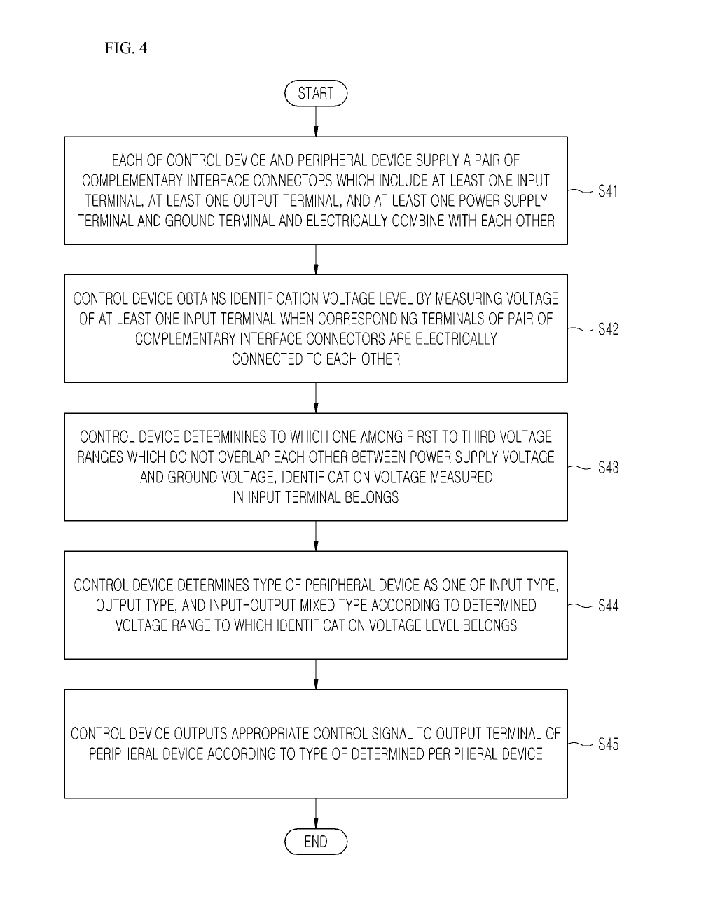

FIG. 4 is a flowchart showing a method of interfacing a general-purpose peripheral device, by which a control device identifies a peripheral device connected through a general-purpose peripheral interface according to an exemplary embodiment of the present invention.

Referring to FIG. 4, the method of interfacing the general-purpose peripheral device may include a process step S41 in which each of a control device 10 and a peripheral device 20, 30, or 40 supplies a pair of complementary interface connectors including at least one input terminal IN, at least one output terminal OUT1 and OUT2, and at least one power supply terminal VCC and ground terminal GND to electrically combine with each other.

In a process step S42, the control device 10 obtains an identification voltage level by measuring a voltage of the at least one input terminal IN when corresponding terminals of the pair of complementary interface connectors are electrically connected to each other.

In a process step S43, the control device 10 determines to which one among first to third voltage ranges which do not overlap each other between the power supply voltage and the ground voltage the identification voltage measured in the input terminal IN belongs.

In a process step S44, the control device 10 determines the type of the peripheral devices 20, 30, or 40 as one of an input type, an output type, and an input-output mixed type, according to the determined voltage range to which the identification voltage level belongs.

In a process step S45, the control device 10 outputs an appropriate control signal to the output terminals OUT1 and OUT2 of the peripheral device 20, 30, or 40 according to the determined type of the peripheral device 20, 30, or 40.

The exemplary embodiments of the present invention can be applied to a variety of general-purpose peripheral interfaces.

In the general purpose peripheral interface, the robot control device including the same, and the method of interfacing according to the exemplary embodiments of the present invention, manufacturing costs can be reduced since only interfaces with a unified standard are required.

The general purpose peripheral interface, the robot control device including the same, and the method of interfacing according to the exemplary embodiments of the present invention can correspond to various combinations of peripheral devices by preparing a number of interfaces with a unified standard.

In the general purpose peripheral interface, the robot control device including the same, and the method of interfacing according to the exemplary embodiments of the present invention, when different types of peripheral devices are connected to interfaces with a unified standard, a control device can identify the types of connected peripheral devices by itself and input or output a required signal according to the result of the identification.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A general-purpose peripheral interface, comprising a pair of complementary connectors including at least one input terminal, at least one output terminal, and at least one power supply terminal and ground terminal,
wherein when a connector of a peripheral device is combined to a connector of a control device, an identification voltage in a voltage range varying according to a type of the peripheral device is shown in the input terminal.

2. The general-purpose peripheral interface of claim 1, wherein the voltage ranges are set not to overlap each other when the types of the peripheral devices are different.

3. The general-purpose peripheral interface of claim 2, wherein the type of the peripheral device is one of an input type, an input-output mixed type, and an output type.

4. The general-purpose peripheral interface of claim 3, wherein when the type of the peripheral device is the input type, the at least one output terminal is floating, and the input terminal shows the identification voltage in a voltage range relatively closer to a ground voltage, and
when the type of the peripheral device is the output type, the at least one output terminal outputs a control signal for the peripheral device, and the input terminal shows the identification voltage in a voltage range relatively closer to a power supply voltage.

5. The general-purpose peripheral interface of claim 3, wherein when the type of the peripheral device is the input type, the at least one output terminal is floating, and the input terminal shows the identification voltage in a first voltage range relatively closer to a ground voltage,
when the type of the peripheral device is the output type, the at least one output terminal outputs a control signal for the peripheral device, and the input terminal shows the identification voltage in a third voltage range relatively closer to a power supply voltage, and
when the type of the peripheral device is the input-output mixed type, the at least one output terminal outputs a control signal for the peripheral device, and the input terminal shows the identification voltage in a second voltage range between the first voltage range and the third voltage range.

6. A robot control device implementing a robot function using at least one peripheral device, comprising:
a general-purpose peripheral interface using a pair of complementary connectors including at least one input terminal, at least one output terminal, and at least one power supply terminal and ground terminal, wherein when a connector of the peripheral device is combined to a connector of the robot control device, an identification voltage in a voltage range varying according to the type of the peripheral device is shown in the input terminal; and
an identifier identifying the type of the peripheral device as one of an input type, an input-output mixed type, and an output type according to the voltage range of the identification voltage.

7. The robot control device of claim 6, wherein when the type of the peripheral device is the input type, the at least one output terminal is floating and the input terminal shows the identification voltage in a first voltage range relatively closer to a ground voltage,
when the type of the peripheral device is the output type, the at least one output terminal outputs a control signal for the peripheral device, and the input terminal shows the identification voltage in a third voltage range relatively closer to a power supply voltage, and
when the type of the peripheral device is the input-output mixed type, the at least one output terminal outputs a control signal for the peripheral device, and the input terminal shows the identification voltage in a second voltage range between the first voltage range and the third voltage range.

8. A method of a general-purpose peripheral interfacing for a robot control device implementing a robot function using at least one peripheral device, comprising:
supplying, by each of the robot control device and the peripheral device, a pair of complementary interface connectors which include at least one input terminal, at least one output terminal, and at least one power supply terminal and ground terminal and electrically combine with each other;
measuring an identification voltage shown in the at least one input terminal when corresponding terminals of the pair of complementary interface connectors are electrically connected to each other; and
identifying a type of the peripheral device according to a voltage range of the identification voltage.

9. The method of claim 8, wherein the identifying of the type of the peripheral device according to the voltage range of the identification voltage comprises:
determining to which one among first to third voltage ranges which do not overlap each other between a power supply voltage and a ground voltage the identification voltage belongs; and
determining the type of the peripheral device as one of an input type, an output type, and an input-output mixed type according to the determined voltage range to which the identification voltage belongs.

10. The method of claim 9, wherein when the type of the peripheral device is the input type, the at least one output terminal is floating and the input terminal shows the identification voltage in the first voltage range relatively closer to the ground voltage,
when the type of the peripheral device is the output type, the at least one output terminal outputs a control signal for the peripheral device, and the input terminal shows the identification voltage in the third voltage range relatively closer to the power supply voltage, and
when the type of the peripheral device is the input-output mixed type, the at least one output terminal outputs a control signal for the peripheral device, and the input terminal shows the identification voltage in the second voltage range between the first voltage range and the third voltage range.
